(19) United States
(12) Patent Application Publication
(10) Pub. No.: US 2024/0307854 A1
(43) Pub. Date: Sep. 19, 2024

(54) EXHAUST GAS PURIFYING CATALYST

(71) Applicant: TOYOTA JIDOSHA KABUSHIKI KAISHA, Toyota-shi (JP)

(72) Inventors: Hiroki SHIRAKAWA, Seto-shi (JP); Takahiro NISHIO, Nagoya-shi (JP); Shogo SHIRAKAWA, Toyota-shi (JP)

(21) Appl. No.: 18/413,452

(22) Filed: Jan. 16, 2024

(30) Foreign Application Priority Data
Mar. 13, 2023 (JP) 2023-038897

(51) Int. Cl. B01J 23/46; B01D 53/94; B01J 21/04; B01J 37/02; B01J 37/08; F01N 3/28

(52) U.S. Cl. CPC B01J 23/464; B01D 53/9413; B01J 21/04; B01J 37/0205; B01J 37/0236; B01J 37/088; F01N 3/2803; B01D 2255/1025; B01D 2257/404; B01D 2258/01; F01N 2370/02

(57) ABSTRACT

The present disclosure provides an exhaust gas purifying catalyst having improved durability of rhodium, which comprises a carrier and rhodium (Rh), wherein the carrier comprises aluminum oxide (Al₂O₃), and 15% to 60% of the rhodium is dissolved in the carrier.

### CROSS REFERENCE TO RELATED APPLICATIONS

The present application claims priority from Japanese patent application JP 2023-038897 filed on Mar. 13, 2023, the entire content of which is hereby incorporated by reference into this application.

### BACKGROUND

### Technical Field

The present disclosure relates to an exhaust gas purifying catalyst.

### Background Art

An exhaust gas discharged from an internal combustion engine of an automobile etc. contains harmful components such as carbon monoxide (CO), hydrocarbons (HC), and nitrogen oxides (NOx). These harmful components are purified by an exhaust gas purifying catalyst and then released into the atmosphere. Conventionally, a three-way catalyst that simultaneously oxidizes CO, HC and reduces NOx is used as the exhaust gas purifying catalyst. As the three-way catalyst, a catalyst using a noble metal such as platinum (Pt), palladium (Pd), or rhodium (Rh) as a catalyst metal is widely used.

Due to recent increase in price of noble metals, the effect of cost reduction by reducing the amount of noble metals has become larger than before. Among the noble metals, rhodium has the highest price, and a large cost reduction effect can be obtained even if the amount of rhodium is reduced by several percent.

One method for reducing the amount of rhodium used in the exhaust gas purifying catalyst is to improve the durability of the rhodium. Techniques for improving the durability of rhodium include, for example, rhodium sintering suppression techniques. As such a technique, JP 2013-6147 A discloses a technique for controlling a molar average value of Pauling electronegativity for a predetermined element of a catalyst layer in an exhaust gas purifying catalyst including a rhodium catalyst layer and a platinum catalyst layer.

Here, the exhaust gas purifying catalyst for automobiles is used in a severe environment in which a high temperature and an air-fuel ratio (A/F) are changed. Therefore, in the exhaust gas purifying catalyst for an automobile, it is necessary to ensure the exhaust gas purification performance in the use environment, and an excessive amount of rhodium is usually present in the initial state. Therefore, there is room for improvement in reducing the amount of rhodium used in the exhaust gas purifying catalyst.

### SUMMARY

As described above, in the conventional exhaust gas purifying catalyst using rhodium, there is room for improvement in terms of improving the durability of rhodium and reducing the amount of rhodium used. Therefore, the present disclosure provides an exhaust gas purifying catalyst having improved durability of rhodium.

The present inventors have found that the durability of rhodium can be improved by dissolving a predetermined proportion of rhodium in a carrier, and have completed the present disclosure.

That is, the gist of the present disclosure is as follows.
(1) An exhaust gas purifying catalyst comprising a carrier and rhodium (Rh), wherein the carrier comprises aluminum oxide (Al₂O₃), and 15% to 60% of the rhodium is dissolved in the carrier.
(2) The exhaust gas purifying catalyst according to (1), wherein 25% to 60% of the rhodium is dissolved in the carrier.
(3) The exhaust gas purifying catalyst according to (1) or (2), comprising the rhodium in an amount of 0.05% by weight to 1.0% by weight based on the carrier.
(4) The exhaust gas purifying catalyst according to any one of (1) to (3), comprising the rhodium in an amount of 0.1% by weight to 0.5% by weight based on the carrier.

According to the present disclosure, it is possible to provide an exhaust gas purifying catalyst having improved durability of rhodium.

### BRIEF DESCRIPTION OF THE DRAWINGS

FIG. 1 is a schematic cross-sectional view showing an embodiment of an exhaust gas purifying catalyst of the present disclosure;

FIG. 2 is a graph showing a relation between Rh solid solution rate and an initial NOx 50% purification temperature or a NOx 50% purification temperature after a durability test in Examples; and

FIG. 3 is a graph showing a relation between Rh concentration and a NOx 50% purification temperature after the durability test in Examples.

### DETAILED DESCRIPTION

Hereinafter, embodiments of the present disclosure are described in detail.

The present disclosure relates to an exhaust gas purifying catalyst (hereinafter, also referred to as a catalyst) comprising a carrier and rhodium (Rh). In the present disclosure, by dissolving rhodium in the carrier at a predetermined ratio, durability of rhodium can be improved and activity of rhodium can be improved.

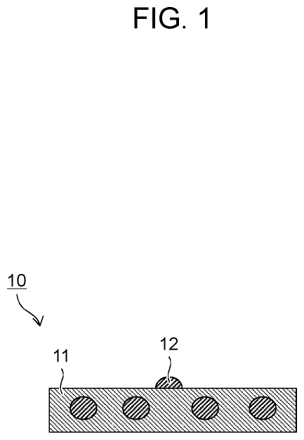

FIG. 1 is a schematic cross-sectional view showing an embodiment of an exhaust gas purifying catalyst of the present disclosure. As shown in FIG. 1, the exhaust gas purifying catalyst 10 comprises a carrier 11 and rhodium 12. In the exhaust gas purifying catalyst 10, a part of the rhodium 12 is dissolved in the carrier 11, and the remainder of the rhodium 12 is placed on the surface of the carrier 11.

The carrier comprises aluminum oxide (Al₂O₃, alumina). The carrier may comprise an oxide of other metal element in addition to Al₂O₃. Examples of the other metal element include metal elements of Group 4 of the periodic table and rare earth elements. The other metal element may be yttrium (Y), lanthanum (La) and zirconium (Zr). When the carrier comprises the oxide of the other metal element, the carrier may be in a form in which the oxide of the other metal element is incorporate in Al₂O₃, or in a form of a composite oxide of Al₂O₃ and the oxide of the other metal element.

The carrier may be La₂O₃-incorporated Al₂O₃ or Al₂O₃—ZrO₂ composite oxide in which La₂O₃ and Y₂O₃ are incorporated.

In the carrier, the content of Al₂O₃ may be from 10% by weight to 100% by weight, may be from 20% by weight to 100% by weight, based on the carrier in some embodiments. In one embodiment, when the carrier is in the form in which the oxide of the other metal element is incorporated in Al₂O₃, the content of the oxide of the other metal element may be 10% by weight or less, may be 5% by weight or less, based on the carrier in some embodiments. In one embodiment, when the carrier is in the form of the composite oxide of Al₂O₃ and the oxide of the other metal element, the content of the oxide of the other metal element may be from 20% by weight to 90% by weight, may be from 40% by weight to 80% by weight, based on the carrier in some embodiments.

The carrier may be in a form of particles. In this case, an average particle size of the carrier may be from 1 μm to 10 μm. The average particle size of the carrier refers to a volume-based average particle size measured by an optical analyzer.

In the catalyst of the present disclosure, rhodium (Rh) is dissolved in the carrier. “Rhodium (Rh) is dissolved in the carrier” means that Rh and Al₂O₃ form a solid solution by penetration or replacement of Rh into a crystalline lattice of Al₂O₃ comprised in the carrier. In some embodiments, Rh penetrates into the crystalline lattice of Al₂O₃.

In the catalyst of the present disclosure, 15% to 60% of rhodium is dissolved in the carrier. That is, in the catalyst of the present disclosure, a solid solution rate of rhodium is 15% to 60%. When the solid solution rate of rhodium is within this range, it is possible to improve a purification performance in use environment (also referred to as “post-durability purification performance”) while maintaining a sufficiently high initial purification performance in the catalyst. In the present disclosure, the “solid solution rate of rhodium” means a rate (%) of a weight of rhodium dissolved in the carrier based on a total weight of rhodium in the catalyst. The solid solution rate of rhodium may be from 20% to 60%, from 25% to 60%, 30% to 55%, and from 30% to 50%, from the viewpoint of achieving both the high initial purification performance and the high purification performance in the use environment of the catalyst.

The solid solution rate of rhodium can be measured by CO pulse adsorption method as described in the following Examples. The CO pulse adsorption method utilizes that CO gas is adsorbed on rhodium and not on the carriers. Specifically, after a sample is heated to 400° C., the sample is subjected to oxidation-reduction pretreatment using oxygen and hydrogen, then the sample is cooled to 0° C. after the reduction, and CO gas is flowed into the sample in a pulse manner, and CO gas content in the output gas is measured. The pulses are introduced until CO gas content is saturated. Since CO gas at the outlet is reduced by the amount of CO gas adsorbed on the rhodium, the amount of the rhodium exposed on the surface can be calculated from the amount of CO gas at the outlet and the amount of the saturated CO gas. Generally, the amount of adsorbed CO gas varies depending on the particle size of the rhodium. The amount of adsorbed CO gas is equivalent to the total amount of rhodium placed on the surface of the carrier because the rhodium used is not nanoparticles but rhodium nitrate. Using this, the rhodium solid solution rate of the respective samples is calculated from the amount of adsorbed CO gas decreased with respect to the amount of adsorbed CO gas of the sample with a rhodium solid solution rate of 0%. In the present disclosure, the solid solution rate of rhodium is a value obtained for the catalyst before use. In the present disclosure, the solid solution rate of rhodium hardly changes from immediately after manufacture of the catalyst to immediately before use of the catalyst, as long as it is in a normal storage state.

The catalyst of the present disclosure may be a mixture of two or more catalysts having different solid solution rates of rhodium, but may be consists of one catalyst.

In the catalyst of the present disclosure, rhodium other than the dissolved rhodium may be placed on the surface of the carrier. In the present disclosure, a sufficient amount of rhodium for initial activity is placed on the surface of the carrier, and the remainder of rhodium is dissolved in the carrier. Therefore, during the use of the catalyst, the dissolved rhodium is precipitated on the surface of the carrier, and it is possible to exhibit high rhodium activity even in the use environment of the catalyst. Therefore, the catalyst of the present disclosure can achieve both high initial purification performance and high purification performance in the use environment of the catalyst.

The catalyst of the present disclosure may comprise the rhodium in an amount of 0.05% by weight to 1.0% by weight, in an amount of 0.1% by weight to 0.5% by weight, based on the carrier. This amount of rhodium refers to a total amount of rhodium in the catalyst (that is, a total weight of rhodium dissolved in the carrier and rhodium placed on the surface). When the rhodium concentration in the catalyst is 0.05% by weight or more, the catalyst has sufficiently high initial purification performance, and when it is 1.0% by weight or less, rhodium is likely to be dissolved in the carrier.

The exhaust gas purifying catalyst of the present disclosure can be produced, for example, as follows. First, a mixture of a carrier and a rhodium salt (for example, rhodium nitrate) is prepared, dried, and then calcined at, for example, 900° C. to 1100° C. to dissolve the rhodium in the carrier. Next, a mixture of a carrier (the carrier may be a carrier in which rhodium is dissolved, obtained as described above) and a rhodium salt is prepared, dried, and then calcined at, for example, 300° C. to 700° C. (400° C. to 600° C. in some embodiments) to support the rhodium on the carrier and place the rhodium on the surface of the carrier.

The carrier which can be used in the manufacture of the catalyst of the present disclosure is those mentioned above for the exhaust gas purification catalyst. The carrier may be commercially available or may be prepared by a known method.

The mixture of the carrier and the rhodium salt can be obtained, for example, by dispersing the carrier in a solvent such as water to prepare a dispersion of the carrier, and adding an aqueous solution of the rhodium salt to the dispersion of the carrier.

The solid solution rate of rhodium can be adjusted by changing, for example, a weight ratio of an amount of rhodium used for dissolving and an amount of rhodium used for surface placement (“Rh for dissolving: Rh for surface placement”). The Rh for dissolving: Rh for surface placement (weight ratio) for obtaining a predetermined solid solution rate of rhodium in the catalyst of the present disclosure is usually 25:75 to 85:15, may be 30:70 to 85:15, 35:65 to 85:15, 50:50 to 80:20, or 50:50 to 75:25. In another embodiment, the Rh for dissolving: Rh for surface placement (weight ratio) is, for example, 30:70 to 80:20, may be 50:50 to 80:20, or 50:50 to 70:30.

The present disclosure also relates to a catalyst obtainable by the above-described production method. In one embodiment, the catalyst of the present disclosure is a catalyst obtainable by a method comprising calcining a mixture of a carrier and a rhodium salt at, for example, 900° C. to 1100° C., to dissolve rhodium in the carrier, and calcining a mixture of the carrier in which rhodium is dissolved and a rhodium salt at, for example, 300° C. to 700° C., to place rhodium on the surface of the carrier, wherein a weight ratio of an amount of rhodium used for dissolving and an amount of rhodium used for surface placement is in the above range.

The exhaust gas purifying catalyst of the present disclosure may be in a form of a powder. The exhaust gas purifying catalyst of the present disclosure may be used as a pellet catalyst by forming a catalyst powder, or may be used as a monolith catalyst by forming a coating layer of a catalyst powder on a heat-resistant honeycomb carrier substrate.

### EXAMPLES

Hereinafter, the present disclosure will be described in more detail with reference to Examples. However, the technical scope of the present disclosure is not limited to these examples.

### Preparation of Catalyst

### Materials Used

Material 1 (Al₂O₃): La₂O₃-incorporated Al₂O₃(La₂O₃:1% by weight)
Material 2 (AZ): Al₂O₃—ZrO₂ composite oxide (Al₂O₃: 30% by weight/ZrO₂: 60% by weight/La₂O₃: 5% by weight/Y₂O₃: 5% by weight)
Material 3 (Rh): An aqueous solution of Rhodium (Rh) nitrate (Rh concentration: 2.75% by weight)

In the following preparation of the catalyst, when the rhodium is dissolved in the carrier to form a solid solution, the rate of the rhodium to be dissolved is set as the target solid solution rate. Next, the amount of rhodium to be used was divided into rhodium to be dissolved (calcination at 950° C.) and rhodium to be surface-placed (calcination at 500° C.) so as to satisfy the target solid solution rate, and each preparation procedure was performed. For example, when the target solid solution rate was 30%, 30% by weight of rhodium of the total amount of rhodium was used for the dissolving step (calcination at 950° C.), and 70% by weight of rhodium of the total amount of rhodium was used for the surface placement step (calcination at 500° C.). The target solid solution rate at the time of preparation was set for convenience of preparation, and was different from the actual solid solution rate of the obtained catalyst.

### Comparative Example 1: Rh 0.2% by Weight/Al₂O₃ Catalyst (Solid Solution Rate: 0%)

To Al₂O₃(Material 1) dispersed in water, 0.2% by weight (as amount of Rh, hereinafter the same) of an aqueous solution of rhodium nitrate (Material 3) was added, stirred for 1 hour, and water was evaporated on a hot stirrer. Thereafter, the mixture was dried at 120° C. overnight and calcined at 500° C. in air.

### Comparative Example 2: Rh 0.2% by Weight/Al₂O₃ Catalyst (Target Solid Solution Rate at the Time of Preparation: 100%)

To Al₂O₃(Material 1) dispersed in water, 0.2% by weight of an aqueous solution of rhodium nitrate (Material 3) was added, stirred for 1 hour, and water was evaporated on a hot stirrer. Thereafter, the mixture was dried at 120° C. overnight and calcined at 950° C. in air.

### Comparative Example 3: Rh 1.0% by Weight/Al₂O₃ Catalyst (Solid Solution Rate: 0%)

To Al₂O₃(Material 1) dispersed in water, 1.0% by weight of an aqueous solution of rhodium nitrate (Material 3) was added, stirred for 1 hour, and water was evaporated on a hot stirrer. Thereafter, the mixture was dried at 120° C. overnight and calcined at 500° C. in air.

### Comparative Example 4: Rh 0.05% by Weight/Al₂O₃ Catalyst (Solid Solution Rate: 0%)

To Al₂O₃(Material 1) dispersed in water, 0.05% by weight of an aqueous solution of rhodium nitrate (Material 3) was added, stirred for 1 hour, and water was evaporated on a hot stirrer. Thereafter, the mixture was dried at 120° C. overnight and calcined at 500° C. in air.

### Comparative Example 5: Rh 0.2% by Weight/AZ Catalyst (Solid Solution Rate: 0%)

The catalyst was prepared in the same manner as in Comparative Example 1 except that AZ (Material 2) was used instead of Al₂O₃(Material 1).

### Example 1: Rh 0.2% by Weight/Al₂O₃ Catalyst (Target Solid Solution Rate at the Time of Preparation: 30%)

To Al₂O₃(Material 1) dispersed in water, 0.06% by weight of an aqueous solution of rhodium nitrate (Material 3) was added, stirred for 1 hour, and water was evaporated on a hot stirrer. Thereafter, the mixture was dried at 120° C. overnight and calcined at 950° C. in air. This was then dispersed again in water, and 0.14% by weight of an aqueous solution of rhodium nitrate (Material 3) was added, stirred for 1 hour, and water was evaporated on a hot stirrer. Thereafter, the mixture was dried at 120° C. overnight and calcined at 500° C. in air.

### Example 2: Rh 0.2% by Weight/Al₂O₃ Catalyst (Target Solid Solution Rate at the Time of Preparation: 50%)

To Al₂O₃(Material 1) dispersed in water, 0.10% by weight of an aqueous solution of rhodium nitrate (Material 3) was added, stirred for 1 hour, and water was evaporated on a hot stirrer. Thereafter, the mixture was dried at 120° C. overnight and calcined at 950° C. in air. This was then dispersed again in water, and 0.10% by weight of an aqueous solution of rhodium nitrate (Material 3) was added, stirred for 1 hour, and water was evaporated on a hot stirrer. Thereafter, the mixture was dried at 120° C. overnight and calcined at 500° C. in air.

### Example 3: Rh 0.2% by Weight/Al₂O₃ Catalyst (Target Solid Solution Rate at the Time of Preparation: 70%)

To Al₂O₃ (Material 1) dispersed in water, 0.14% by weight of an aqueous solution of rhodium nitrate (Material 3) was added, stirred for 1 hour, and water was evaporated on a hot stirrer. Thereafter, the mixture was dried at 120° C. overnight and calcined at 950° C. in air. This was then dispersed again in water, and 0.06% by weight of an aqueous solution of rhodium nitrate (Material 3) was added, stirred for 1 hour, and water was evaporated on a hot stirrer. Thereafter, the mixture was dried at 120° C. overnight and calcined at 500° C. in air.

### Example 4: Rh 0.2% by Weight/Al₂O₃ Catalyst (Target Solid Solution Rate at the Time of Preparation: 80%)

To Al₂O₃ (Material 1) dispersed in water, 0.16% by weight of an aqueous solution of rhodium nitrate (Material 3) was added, stirred for 1 hour, and water was evaporated on a hot stirrer. Thereafter, the mixture was dried at 120° C. overnight and calcined at 950° C. in air. This was then dispersed again in water, and 0.04% by weight of an aqueous solution of rhodium nitrate (Material 3) was added, stirred for 1 hour, and water was evaporated on a hot stirrer. Thereafter, the mixture was dried at 120° C. overnight and calcined at 500° C. in air.

### Example 5: Rh 1.0% by Weight/Al₂O₃ Catalyst (Target Solid Solution Rate at the Time of Preparation: 50%)

To Al₂O₃ (Material 1) dispersed in water, 0.50% by weight of an aqueous solution of rhodium nitrate (Material 3) was added, stirred for 1 hour, and water was evaporated on a hot stirrer. Thereafter, the mixture was dried at 120° C. overnight and calcined at 950° C. in air. This was then dispersed again in water, and 0.50% by weight of an aqueous solution of rhodium nitrate (Material 3) was added, stirred for 1 hour, and water was evaporated on a hot stirrer. Thereafter, the mixture was dried at 120° C. overnight and calcined at 500° C. in air.

### Example 6: Rh 0.05% by Weight/Al₂O₃ Catalyst (Target Solid Solution Rate at the Time of Preparation: 50%)

To Al₂O₃ (Material 1) dispersed in water, 0.025% by weight of an aqueous solution of rhodium nitrate (Material 3) was added, stirred for 1 hour, and water was evaporated on a hot stirrer. Thereafter, the mixture was dried at 120° C. overnight and calcined at 950° C. in air. This was then dispersed again in water, and 0.025% by weight of an aqueous solution of rhodium nitrate (Material 3) was added, stirred for 1 hour, and water was evaporated on a hot stirrer. Thereafter, the mixture was dried at 120° C. overnight and calcined at 500° C. in air.

### Example 7: Rh 0.2% by Weight/AZ Catalyst (Target Solid Solution Rate at the Time of Preparation: 50%)

The catalyst was prepared in the same manner as in Example 2 except that AZ (Material 2) was used instead of Al₂O₃(Material 1).

The compositions of the catalysts of Examples 1-7 and Comparative Examples 1-5 are shown in Table 1 below.

TABLE 1
List of Comparative Examples and Examples

| | | | | | | | | | | | Comparative | |
|---|---|---|---|---|---|---|---|---|---|---|---|---|
| | Comparative Examples | | | | Examples | | | | | | Example | Example |
| | 1 | 2 | 3 | 4 | 1 | 2 | 3 | 4 | 5 | 6 | 5 | 7 |
| PGM | Rh | | | | | | | | | | | |
| Carrier | Al₂O₃ | | | | | | | | | | AZ | |
| Rh content (% | 0.2 | | 1.0 | 0.05 | 0.2 | | | | 1.0 | 0.05 | 0.2 | |
| by weight) | | | | | | | | | | | | |
| Rh solid | 0 | 67.7 | 0 | 0 | 19.9 | 33.7 | 47 | 54.1 | 22.1 | 43.4 | 0 | 28.5 |
| solution | | | | | | | | | | | | |
| rate (%) | | | | | | | | | | | | |
| NOx_50% | 291.5 | 364.6 | 225.3 | 370.5 | 292.0 | 290.3 | 298.4 | 324.2 | 232.1 | 390.5 | 287.8 | 296.2 |
| purification | | | | | | | | | | | | |
| temperature_ini- | | | | | | | | | | | | |
| tial (° C.) | | | | | | | | | | | | |
| NOx_50% | 371.6 | 368 | 258.9 | 400.2 | 364.4 | 357.9 | 362.6 | 359.5 | 247.7 | 395.6 | 380.3 | 370.4 |
| purification | | | | | | | | | | | | |
| temperature_after | | | | | | | | | | | | |
| durability | | | | | | | | | | | | |
| test (° C.) | | | | | | | | | | | | |

### <Measurement of Solid Solution Rate>

For the catalysts of Examples 1 to 7 and Comparative Examples 1 to 5, the solid solution rate of rhodium was measured by CO pulse adsorption method as follows. The CO pulse adsorption method utilizes that CO gas is adsorbed on rhodium and not on the carriers. Specifically, after the sample was heated to 400° C., the sample was subjected to oxidation-reduction pretreatment using oxygen and hydrogen, then the sample was cooled to 0° C. after the reduction, and CO gas was flowed into the sample in a pulse manner, and CO gas content in the output gas was measured. The pulses were introduced until CO gas content was saturated. Since CO gas at the outlet is reduced by the amount of CO gas adsorbed on the rhodium, the amount of the rhodium exposed on the surface can be calculated from the amount of CO gas at the outlet and the amount of the saturated CO gas. Generally, the amount of adsorbed CO gas varies depending on the particle size of the rhodium. The amount of adsorbed CO gas is equivalent to the total amount of rhodium placed on the surface of the carrier because the rhodium used is not nanoparticles but rhodium nitrate. Using this, the rhodium solid solution rate of the respective samples was calculated from the amount of adsorbed CO gas decreased with respect to the amount of adsorbed CO gas of the sample with a rhodium solid solution rate of 0%.

### <Performance Evaluation>

For the catalysts of Examples 1 to 7 and Comparative Examples 1 to 5, initial purification performance (before the durability test) and purification performance after the durability test was evaluated as follows.

The catalyst powders were pressure-formed at a pressure of 1 ton by cold isostatic pressing (CIP), and then sieved with grinding to obtain pellet catalysts. These catalysts were used as samples for evaluation of the initial purification performance.

In addition, the pellet catalysts were subjected to a durability test, and the catalysts after the durability test were used as samples for evaluation of the purification performance after the durability test. The durability test was carried out by alternately exposing the pellet catalysts to a stoichiometric air-fuel mixture (A/F=14.6) and an oxygen-rich air-fuel mixture (lean: A/F>14.6) at a constant period of time ratio of 1:1 for 5 hours while heating the pellet catalysts to 1000° C.

For the samples, temperatures when 50% purification rate of NOx was reached were measured as the purification performance of the catalysts. Specifically, 2 g of the samples for evaluation were placed in a flow-through reactor, heated to 500° C. at a heating rate of 50° C./min in a model gas for evaluation shown in Table 2 below, held at this temperature for 10 minutes, and then cooled to 100° C. Next, the samples were heated at a heating rate of 20° C./min, NOx purification rates during heating were measured, and the temperatures when 50% purification rate of NOx in the gases was reached (NOx 50% purification temperature, NOx-T50) were calculated. The lower the temperature when 50% purification rate of NOx is reached is, the better the purification performance is.

TABLE 2
Model gas for evaluation

| | Composition of gas | | | | | | | |
|---|---|---|---|---|---|---|---|---|
| | NO | O₂ | CO₂ | C₃H₆ | CO | H₂O | N₂ | Gas flow rate |
| | ppm | | | | | | | L/minute |
| Model gas | 3200 | 5000 | 140000 | 1000 | 5200 | 30000 | Remainder | 15 |

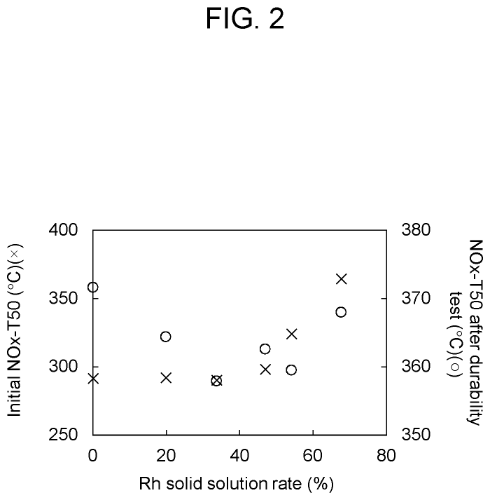

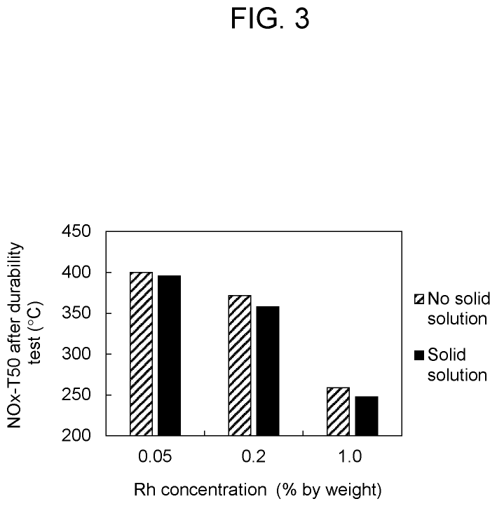

Table 1 shows evaluation results for the catalysts of Examples 1 to 7 and Comparative Examples 1 to 5. Further, FIG. 2 shows, for the catalysts (Examples 1 to 4 and Comparative Examples 1, 2) wherein Rh content is 0.2% by weight and the carrier is Al₂O₃, the relation between Rh solid solution rate and the initial NOx 50% purification temperature or the NOx 50% purification temperature after the durability test. In addition, FIG. 3 shows, for the catalysts with rhodium dissolved (solid solution) (Examples 2, 5, and 6) and the catalysts without rhodium dissolved (no solid solution) (Comparative Examples 1, 3, and 4), the relation between Rh content and NOx 50% purification temperature after the durability test.

As shown in Table 1 and FIG. 2, it was possible to suppress sintering of rhodium by dissolving rhodium in the carrier and to improve NOx purification performance after the durability test. On the other hand, when Rh solid solution rate was increased to close to 70%, the purification performance after the durability test was sufficiently higher, but the initial purification performance significantly decreased. In the catalyst of the present disclosure, when the solid solution rate of rhodium is 15% to 60%, both the high initial purification performance and the high purification performance after the durability test can be achieved.

Further, as shown in Table 1 and FIG. 3, when the rhodium content (Rh concentration) in the catalyst is 0.05% by weight to 1.0% by weight based on the carrier, it was confirmed that the purification performance after the durability test was improved by dissolving the rhodium in the carrier. When the Rh concentration is less than 0.05% by weight, the initial purification performance is significantly decreased. When the Rh concentration is higher than 1.0% by weight, it is expected that rhodium is less likely to be dissolved in the carrier comprising Al₂O₃.

All publications, patents, and patent applications cited herein are incorporated herein by reference in their entirety.

What is claimed is:

1. An exhaust gas purifying catalyst comprising a carrier and rhodium (Rh), wherein the carrier comprises aluminum oxide (Al₂O₃), and 15% to 60% of the rhodium is dissolved in the carrier.

2. The exhaust gas purifying catalyst according to claim 1, wherein 25% to 60% of the rhodium is dissolved in the carrier.

3. The exhaust gas purifying catalyst according to claim 1, comprising the rhodium in an amount of 0.05% by weight to 1.0% by weight based on the carrier.

4. The exhaust gas purifying catalyst according to claim 3, comprising the rhodium in an amount of 0.1% by weight to 0.5% by weight based on the carrier.
